(19) United States
(12) Patent Application Publication
(10) Pub. No.: US 2007/0099159 A1
(43) Pub. Date: May 3, 2007

(54) Foreign language instructional aid

(76) Inventor: Karin Valencia, Johnstown, PA (US)

Correspondence Address: ANDREW MCALEAVEY, 4600 ADELINE ST., #101, EMERYVILLE, CA, 94608, US

(21) Appl. No.: 11/262,572

(22) Filed: Oct. 31, 2005

(51) Int. Cl. G09B 1/00

(52) U.S. Cl. 434/160

(57) ABSTRACT

A foreign language instructional aid in the form of a verb conjugation kit is disclosed. The kit includes a number of subject pieces, a number of verb stem pieces, and a number of verb ending pieces. Each of the pieces includes an informational surface on which a subject, verb stem, or verb ending is printed. Each of the pieces also includes an adhesive surface adapted to attach to an attachment surface. Each set of subject pieces, each set of verb stem pieces, and each set of verb ending pieces has a unique identifying characteristic, such as a unique color. In one embodiment, the adhesive surface of the pieces is magnetic and the attachment surface is magnetic.

### BACKGROUND OF THE INVENTION

1. Field of the Invention

The invention pertains to the field of foreign language instructional aids.

2. Description of Related Art

Foreign language instruction has long been a part of education in the United States and in many other parts of the world. In some cases, instruction may begin in the first year of schooling and continue on through the end of secondary school and into university studies. In other cases, especially in the United States, foreign language instruction may commence in the sixth, seventh, or eighth grades, just before high school. The Romance languages are commonly taught, particularly Spanish and French, although some schools also teach other languages.

One of the more difficult skills for students to master is that of verb conjugation, the process of applying an ending to a verb that matches the subject or subject pronoun of the sentence. Most Romance languages have sets of verbs that follow defined rules for conjugation, as well as irregular verbs that do not, and it becomes difficult for many students to remember and correctly apply the applicable grammatical rules for each verb.

Various instructional aids are available in the classroom, ranging from traditional textbooks to flashcards and computer-aided language instruction tools. However, foreign language instructors continue to search for instructional aids that are clear, simple, relatively inexpensive, and accessible to students of different ages and ability levels.

### SUMMARY OF THE INVENTION

One aspect of the invention relates to a foreign language verb conjugation kit. The foreign language verb conjugation kit comprises one or more subject pieces, one or more verb stem pieces, one or more verb ending pieces, and an attachment surface. The subject pieces have an adhesive surface and an informational surface on which a subject is indicated. The subject pieces also have a uniform identifying characteristic of a first type. The verb stem pieces have an adhesive surface and an informational surface on which a verb stem is indicated. The verb stem pieces also have a uniform identifying characteristic of a second type. The verb ending pieces have an adhesive surface and an informational surface on which a verb ending is indicated. The verb ending pieces also have a uniform identifying characteristic of a third type. The attachment surface is adapted to allow the adhesive surfaces of the subject pieces, the verb stem pieces, and the verb ending pieces to releasably adhere. The attachment surface has sufficient size to accommodate at least one subject piece, at least one verb stem piece, and at least one verb ending piece.

Another aspect of the invention relates to a foreign language instructional method. The method comprises teaching proper verb conjugation in a foreign language by causing or allowing one or more students to assemble subject pieces, verb stem pieces, and verb ending pieces into phrases with correct verb conjugations. The subject pieces have an adhesive surface and an informational. surface on which a subject is indicated. The subject pieces also have a uniform identifying characteristic of a first type. The verb stem pieces have an adhesive surface and an informational surface on which a verb stem is indicated. The verb stem pieces also have a uniform identifying characteristic of a second type. The verb ending pieces have an adhesive surface and an informational surface on which a verb ending is indicated. The verb ending pieces also have a uniform identifying characteristic of a third type.

Yet another aspect of the invention relates to a foreign language instructional method. The method comprises prompting one or more students with a correct verb conjugation or a portion of a correct verb conjugation and allowing the one or more students to assemble the correct verb conjugation or another correct verb conjugation using individual verb conjugation kits. The individual verb conjugation kits comprise sets of subject pieces, verb stem pieces, and verb ending pieces. The subject pieces also have a uniform identifying characteristic of a first type. The verb stem pieces have an adhesive surface and an informational surface on which a verb stem is indicated. The verb stem pieces also have a uniform identifying characteristic of a second type. The verb ending pieces have an adhesive surface and an informational surface on which a verb ending is indicated. The verb ending pieces also have a uniform identifying characteristic of a third type.

These and other aspects, features, and advantages of the invention will become clear from the description that follows.

### BRIEF DESCRIPTION OF THE DRAWINGS

The invention will be described with respect to the following drawing figures, in which like numerals represent like elements throughout the views, and in which:

FIG. 1 is a top plan view of an instructional aid according to one embodiment of the invention;

FIG. 2 is a cross-sectional view of one of the pieces of the instructional aid of FIG. 1;

FIG. 3 is a perspective view of a container that may be used with the instructional aid of FIG. 1;

FIG. 4 is a perspective view of another embodiment of an instructional aid suitable for a classroom setting; and

FIG. 5 is a perspective view of another embodiment of an instructional aid using hook and loop fastener for attachment.

### DETAILED DESCRIPTION

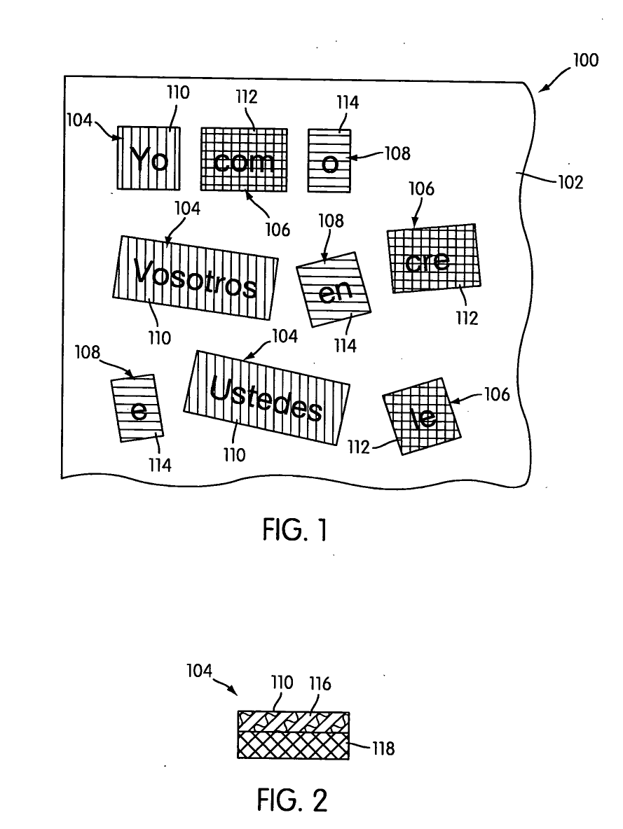

FIG. 1 is a top plan view of an instructional aid, generally indicated at 100, according to one embodiment of the invention. In the illustrated embodiment, the instructional aid is a foreign language verb conjugation kit.

The foreign language verb conjugation kit 100 illustrated in the figures and described below may be adapted for any of the Romance languages, and also for any other language amenable to verb conjugation. The group of Romance languages is generally considered to include Spanish, Portuguese, Catalan, Galician, French, Haitian, Occitan, Romansh, Italian, Sardinian, the Northern Italian dialects, and Romanian, of which at least Spanish, French, and Italian are widely taught as foreign languages. Other languages amenable to use with the foreign language verb conjugation kit 100 include Latin. However, in the description that follows, certain examples will be given of its use as a Spanish language verb conjugation kit.

As shown in FIG. 1, the verb conjugation kit 100 includes an attachment surface 102 and a plurality of pieces. The pieces include one or more subject pieces 104, one or more verb stem pieces 106, and one or more verb ending pieces 108. The pieces 104, 106, 108 adhere and are releasably attached to the attachment surface 102. In the illustrated embodiment, the pieces 104, 106, 108 are all relatively thin and rectangular in shape, although in other embodiments, any shape may be used.

The subject pieces 104 comprise an outwardly-facing informational surface 110 that includes a printed subject or subject pronoun. The verb stem pieces 106 comprise an outwardly-facing informational surface 112 that includes a printed verb stem without an ending. The verb ending pieces 108 comprise an outwardly-facing informational surface 114 that includes a printed verb ending.

The subject pieces 104, verb stem pieces 106, and verb ending pieces 108 have respective uniform identifying characteristics that help to identify them. In the illustrated embodiment, the informational surfaces 110 of the subject pieces 104 are colored red, the informational surfaces 112 of the verb stem pieces 106 are colored yellow, and the informational surfaces 114 of the verb ending pieces 108 are colored blue. Therefore, subject pieces 104 can easily be distinguished from verb stem pieces 106, and so forth. In other embodiments, the uniform identifying characteristics of the various sets of pieces 104, 106, 108 could be different. For example, each set of pieces 104, 106, 108 could have a different shape, so that verb stems and verb endings could be distinguishable on the basis of shape.

With the arrangement of the pieces 104, 106, 108 and the attachment surface 102, a user can manipulate the pieces 104, 106, 108 to properly conjugate verbs. For example, as shown in FIG. 1, a user can assemble the pieces 104, 106, 108 on the attachment surface 102 proximate to one another so as to create the phrase “Yo como,” which represents the correct conjugation of the Spanish verb “comer” for the subject pronoun “Yo,” the phrase itself meaning “I eat.” The attachment surface 102 is sized to accommodate at least one subject piece 104, at least one verb stem piece 106, and at least one verb ending piece 108, although the attachment surface 102 typically is of sufficient size to accommodate several pieces 104, 106, 108 at once.

FIG. 2 is a sectional view of one of the subject pieces 104, illustrating its construction. Although a subject piece 104 is illustrated in FIG. 2, the construction of the verb stem and verb ending pieces 106, 108 is the same as that of the subject pieces 104. As shown, the pieces 104, 106, 108 comprise a top layer 116, the upper surface of which is the informational surface 110, and a bottom adhesive layer 118 that enables the pieces 104, 106, 108 to adhere to the attachment surface 102.

As used here, the term “adhesive layer” is used in the broad sense to refer to any mechanism that allows the piece 104, 106, 108 to adhere to the attachment surface 102. In the embodiment, the adhesive layer 118 is a thin, flexible magnetic layer and the attachment surface 102 is comprised of a complementary magnetic material. In other embodiments, the adhesive layer 118 may be, for example, a layer of hook-and-loop fastener, with the attachment surface 102 having a complementary layer of hook-and-loop fastener. In yet other embodiments, the adhesive layer 118 may be a layer of reusable glue-adhesive.

The top layer 116 may be constructed in a number of ways. For example, the top layer 116 may be a layer screen printed over the top of the adhesive layer 118. The top layer 116 may also be a piece of paper adhered or fastened to the adhesive layer 118, or, in some embodiments, a piece of plastic fused to the adhesive layer 118.

FIGS. 1 and 2 illustrate a relatively general embodiment of the foreign language verb conjugation kit. The attachment surface 102 may be of any size or overall shape conducive to instructional purposes. In some embodiments, the attachment surface 102 may be a portion or the entirety of a classroom blackboard or whiteboard and the pieces 104, 106, 108 may be sized so as to be seen from a distance from the blackboard or whiteboard attachment surface 102. In other embodiments, the attachment surface 102 may be a board or sheet sized for individual student use.

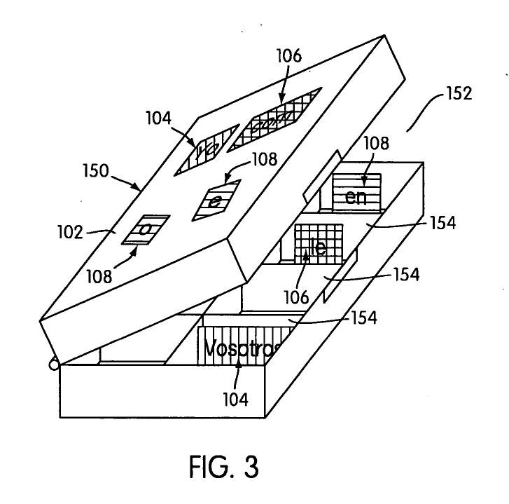

FIG. 3 is a perspective view of a container 150 that is adapted to hold the pieces 104, 106, 108. The container 150 is generally of a clamshell-type construction, and the attachment surface 102, in the illustrated embodiment, a metal or metal-laminated plate, comprises an outer surface of the container 150. Within the container 150 is a compartment 152 in which a number of pieces 104, 106, 108 can be stored. Depending on the embodiment, multiple surfaces of the container 150 may serve as attachment surfaces 102. In the illustrated embodiment, the container 150 also includes internal dividers 154 that separate subject pieces 104 from verb stem pieces 106 and verb ending pieces 108 for storage purposes, in order to facilitate easy and organized access to the pieces 104, 106, 108. Although not shown in the figure, the container 150 could include instructions to a user printed on an interior surface.

In other embodiments, the container may be of any material. For example, the container may be made of paper or cardboard affixed with a magnetic material that would serve as an attachment surface 102.

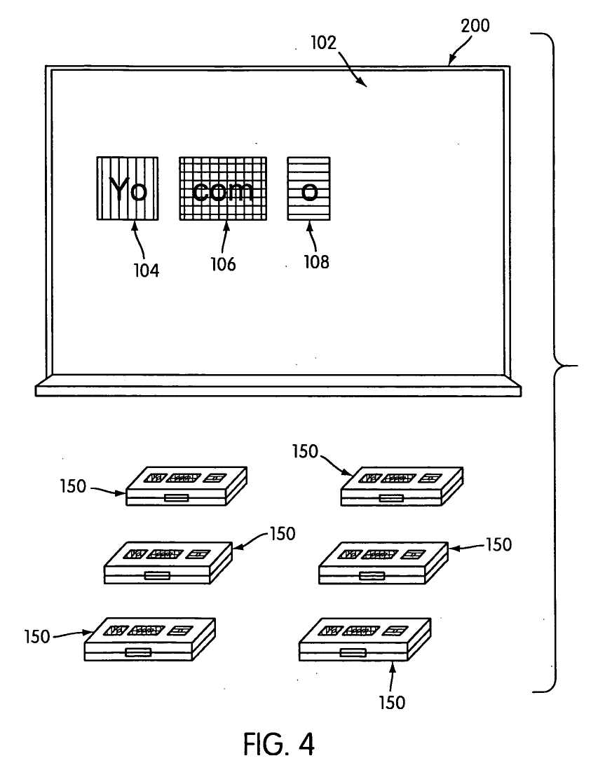

FIG. 4 is a perspective view of another embodiment of the invention suitable for classroom use. In the embodiment shown in FIG. 4, the foreign language verb conjugation kit 100 can be used simultaneously by students and instructor. As shown in FIG. 4, a large version of the foreign language verb conjugation kit 200 is sized for a blackboard, whiteboard, or other classroom-sized display. The attachment surface 102 of the large conjugation kit 200 may be a portion of a blackboard or whiteboard, a surface with hook-and-loop fastener, or another suitable surface. If not embodied in a blackboard or whiteboard, the attachment surface 102 of the large conjugation kit 200 may be a board suitable for set-up on an easel or other classroom display. The pieces 104, 106, 108 of the large conjugation kit 200 are sized so as to be seen by the entire classroom, and have an adhesive layer 118 appropriate for the attachment surface 102 to which they are to adhere. If the attachment surface 102 is, for example, a whiteboard with a ferromagnetic metallic substrate, the adhesive layer 118 of the pieces 104, 106, 108 may be magnetic, as illustrated in FIG. 2. (Note that although the pieces 104, 106, 108 of the large verb conjugation kit 200 may be larger and have slightly different features than their smaller counterparts in the verb conjugation kit 100, for the sake of simplicity, they are given the same reference numerals in this description.)

In addition to the large verb conjugation kit 200, a number of individual student verb conjugation kits 100 are provided, so that students may follow exercises that are demonstrated on the large verb conjugation kit 200 and may perform their own exercises on their own verb conjugation kits 100 at the direction of the instructor. Specifically, FIG. 4 shows a plurality of containers 150 with subject, verb, and verb ending pieces 104, 106, 108.

Depending on the embodiment and the instructional methods, there are many ways in which the verb conjugation kits 100, 200 may be used. For example, an instructor may assemble certain phrases using the large verb conjugation kit 200 and ask the students to follow along using their own verb conjugation kits 100; the instructor may assemble a phrase using the large verb conjugation kit 200 and ask students to conjugate the verb with other subject pronouns using either the large verb conjugation kit 200 or their own verb conjugation kits 100; or the instructor may use a partial conjugation or partial phrase (e.g., “Yo com”) as a prompt, allowing the students to select the pieces 104, 106, 108 that would properly complete the phrase. Other methods of using the verb conjugation kits 100, 200 are also possible, depending on the objectives of the instructor.

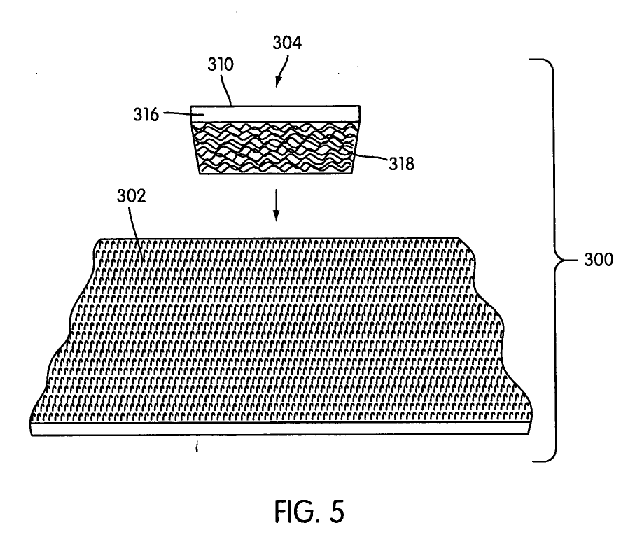

As was described above, a verb conjugation kit in some embodiments of the invention may include hook and loop fastener. FIG. 5 is a perspective view of a verb conjugation kit 300 that uses hook and loop fastener. The attachment surface 302 of the verb conjugation kit 300 includes hooks. A piece, indicated generically at 304, includes an adhesive layer 318 with loops sized to engage the hooks of the attachment surface 302, as well as a top layer 316 and an informational layer 310.

The particular vocabulary included in foreign language verb conjugation kits 100, 200, 300 may include any subjects, verb stems, and verb endings that are deemed to be appropriate in the instructional process. Multiple pieces 104, 106, 108 with the same subject, verb stem, or verb ending may be included in each kit 100, allowing the user to simultaneously conjugate the same verb several different ways or different verbs the same way. If used instructionally in the classroom, distinct vocabulary sets of subject pieces 104, verb stem pieces 106, and verb ending pieces 108 may be stored together and given to students at appropriate times. For example, with respect to Spanish language instruction, different vocabulary sets for “-er,” “-ir,” and “-ar” verbs may be created. As an example, some of the subjects, verb stems, and verb endings that may be included are listed below in Tables 1-3.

TABLE 1
Spanish-language “-er” verb conjugation set

| Subjects | Verb Stems | Verb Endings |
|---|---|---|
| El, Ella, | aprend, beb, com, | e, eis, en, |
| Ellas, Ellos, | comprend, corr, cos, ere, | emos, es, o |
| Nosotras, | deb, escond, le, met, ofend, | |
| Nosotros, Tu, | promet, respond, romp, sab, | |
| Ustedes, | sorprend, suced, tem, tos, | |
| Vosotras, | ve, vend | |
| Vosotros, Yo | | |

TABLE 2
Spanish-language “-ir” verb conjugation set

| Subjects | Verb Stems | Verb Endings |
|---|---|---|
| El, Ella, | abr, admit, aplaud, asist, | e, en, es, |
| Ellas, Nosotros, | bat, combat, consum, cubr, | imos, is, o |
| Tu, Ustedes, | cumpl, decid, despid, divid, | |
| Vosotras, | escrib, grun, insist, prohib, | |
| Vosotros | recib, sacud, sal, sobreviv, | |
| | sub, sufr, viv | |

TABLE 3
Spanish-language “-ar” verb conjugation set

| Subjects | Verb Stems | Verb Endings |
|---|---|---|
| El, Ella, | ayud, acept, arregi, bail, | a, ais, amos, |
| Ellas, Ellos, | busc, camin, cant, celebr, | an, as, en, o |
| Nosotras, | cocin, compr, dibuj, escuch, | |
| Nosotros, Tu, | estudi, habl, limpi, llam, | |
| Ustedes, | lleg, llev, mir, necesit, pas, | |
| Vosotras, | practic, pregunt, trabaj, torn, | |
| Vosotros Yo | viaj | |

Tables 1-3 include sets of pieces suitable for conjugation in the present tense. Sets for other verb tenses may also be created. Additionally, those of skill in the art will note that Tables 1-3 present relatively basic vocabularies. However, foreign language verb conjugation kits 100, 200, 300 according to embodiments of the invention may be used with any subjects, any verb stems, and any verb endings. For more proficient students, or those beyond the introductory levels, more difficult vocabularies may be used.

While the invention has been described with respect to certain exemplary embodiments, the words that have been used are intended to be illuminating, rather than limiting. Modifications and changes may be made within the scope of the invention, which is defined by the appended claims.

I claim:

1. A foreign language verb conjugation kit, comprising:
one or more subject pieces, each of the subject pieces having an adhesive surface and an informational surface on which a subject is indicated, the subject pieces having a uniform identifying characteristic of a first type;
one or more verb stem pieces, each of the verb stem pieces having an adhesive surface and an informational surface on which a verb stem is indicated, the verb stem pieces having a uniform identifying characteristic of a second type;
one or more verb ending pieces, each of the verb ending pieces having an adhesive surface and an informational surface on which a verb ending is indicated, the verb ending pieces having a uniform identifying characteristic of a third type; and
an attachment surface adapted to allow the adhesive surfaces of the subject pieces, the verb stem pieces, and the verb ending pieces to releasably adhere, the attachment surface having sufficient size to accommodate at least one subject piece, at least one verb stem piece, and at least one verb ending piece.

2. The foreign language verb conjugation kit of claim 1, wherein the uniform identifying characteristic of the first type is a first color, the uniform identifying characteristic of the second type is a second color, and the uniform identifying characteristic of the third type is a third color.

3. The foreign language verb conjugation kit of claim 1, wherein the adhesive surfaces comprise magnetic surfaces and the attachment surface is magnetic.

4. The foreign language verb conjugation kit of claim 1, wherein the adhesive surfaces comprise hook and loop fastener and the attachment surface comprises complementary hook and loop fastener.

5. The foreign language verb conjugation kit of claim 1, further comprising a storage box including the attachment surface.

6. The foreign language verb conjugation kit of claim 1, wherein the foreign language is a Romance language.

7. The foreign language verb conjugation kit of claim 1, wherein the subject pieces, the verb stem pieces, and the verb ending pieces are generally rectangular in shape.

8. A foreign language instructional method, comprising:
teaching proper verb conjugation in a foreign language by causing or allowing one or more students to assemble subject pieces, verb stem pieces and verb ending pieces into phrases with correct verb conjugations,
each of the subject pieces having an adhesive surface and an informational surface on which a subject is indicated, the subject pieces having a uniform identifying characteristic of a first type,
each of the verb stem pieces having an adhesive surface and an informational surface on which a verb stem is indicated, the verb stem pieces having a uniform identifying characteristic of a second type, and
each of the verb ending pieces having an adhesive surface and an informational surface on which a verb ending is indicated, the verb ending pieces having a uniform identifying characteristic of a third type;
wherein the subject pieces, the verb stem pieces, and the verb ending pieces are assembled on an attachment surface adapted to engage with the adhesive surfaces of the subject pieces, the verb stem pieces, and the verb ending pieces.

9. The method of claim 8, wherein the uniform identifying characteristic of the first type is a first color, the uniform identifying characteristic of the second type is a second color, and the uniform identifying characteristic of the third type is a third color.

10. The method of claim 8, wherein the adhesive surfaces comprise magnetic surfaces and the attachment surface is magnetic.

11. The method of claim 8, wherein the adhesive surfaces comprise hook and loop fastener and the attachment surface comprises complementary hook and loop fastener.

12. The method of claim 8, wherein the foreign language is a Romance language.

13. The method of claim 8, wherein the subject pieces, the verb stem pieces, and the verb ending pieces are generally rectangular in shape.

14. A foreign language instructional method, comprising:
prompting one or more students with a correct verb conjugation or a portion of a correct verb conjugation; and
allowing the one or more students to assemble the correct verb conjugation or another correct verb conjugation using individual verb conjugation kits;
wherein the individual verb conjugation kits comprise sets of subject pieces, verb stem pieces, and verb ending pieces,
each of the subject pieces having an adhesive surface and an informational surface on which a subject is indicated, the subject pieces having a uniform identifying characteristic of a first type,
each of the verb stem pieces having an adhesive surface and an informational surface on which a verb stem is indicated, the verb stem pieces having a uniform identifying characteristic of a second type, and
each of the verb ending pieces having an adhesive surface and an informational surface on which a verb ending is indicated, the verb ending pieces having a uniform identifying characteristic of a third type.

15. The method of claim 14, wherein the uniform identifying characteristic of the first type is a first color, the uniform identifying characteristic of the second type is a second color, and the uniform identifying characteristic of the third type is a third color.

16. The method of claim 15, wherein the individual verb conjugation kits include respective attachment surfaces adapted to adhere to the adhesive surfaces of the subject pieces, the verb stem pieces, and the verb ending pieces.

17. The method of claim 16, wherein the prompting comprises prompting using a classroom verb conjugation kit having the subject pieces, the verb stem pieces, and the verb ending pieces.

18. The method of claim 17, wherein the foreign language is a Romance language.

19. The method of claim 18, wherein the foreign language is Spanish.
